(19) United States
(12) Patent Application Publication
(10) Pub. No.: US 2012/0150525 A1
(43) Pub. Date: Jun. 14, 2012

(54) SYSTEM FOR PROVIDING VIRTUAL ELECTRONIC DEVICE

(75) Inventor: Jae Ho LEE, Daejeon (KR)

(73) Assignee: Electronics and Telecommunications Research Institute, Daejeon (KR)

(21) Appl. No.: 13/316,617

(22) Filed: Dec. 12, 2011

(30) Foreign Application Priority Data
Dec. 14, 2010 (KR) 10-2010-0127906

(51) Int. Cl. G06G 7/62

(52) U.S. Cl. 703/20

(57) ABSTRACT

A system for providing a virtual electronic device, which allows a user to experience the use of an actual electronic device like a real experience before purchasing the actual electronic device, is disclosed. The system may include a virtual electronic providing apparatus which includes a virtual electronic device having software and hardware interfaces for executing functions of an actual electronic device and executes the virtual electronic device in response to a request of a user terminal or transmits the virtual electronic device to the user terminal. Thus, the user can experience the major features of the actual electronic device in advance before purchasing the actual electronic device and sufficiently review the basic and additional features of the actual electronic device that the user wants to purchase.

### CROSS-REFERENCE TO RELATED PATENT APPLICATION

This application claims the benefit of Korean Patent Application No. 10-2010-0127906, filed on Dec. 14, 2010, in the Korean Intellectual Property Office, the disclosure of which is incorporated herein in its entirety by reference.

### BACKGROUND OF THE INVENTION

1. Field of the Invention

The present invention relates to a virtualization technology and, more particularly, to a system for providing a virtual electronic device, which allows a user to experience the features of an actual electronic device that the user wants to purchase before actual purchase.

2. Description of the Related Art

Recently, with the development of technologies for convergence of broadcasting and communication and processor technologies, a variety of small electronic devices such as mobile communication terminals, portable multimedia players (PMPs), MP3 players, navigation systems, mobile TVs, etc. have increased explosively.

Moreover, various contents that can be used in the electronic devices have recently been sold in an open market through the Internet, and thus a purchasing environment where a variety of applications, which meet the user's preference other than the basic features installed in an electronic device can be additionally installed at the time of release of the electronic device is provided.

In general, when a consumer purchases an electronic device, the consumer connects to an Internet shopping mall to evaluate the features, functions or design of the electronic device in advance. Otherwise, the consumer directly visits an offline store to receive information on the electronic device from salespeople or to experience the features of the electronic device by simple manipulation and then purchases the electronic device.

However, the information on the electronic device provided by the existing Internet shopping mall is primarily focused on a feature-oriented electronic catalog or specifications, and thus it is impossible for the user to directly manipulate and experience the detailed features of the electronic device or install and use an additional application.

Moreover, when the consumer will purchase the electronic device from the offline store, the consumer should check whether the store has the corresponding electronic device and directly visit the store during business hours of the store, which is quite troublesome.

Furthermore, in order to use a variety of applications related to the electronic devices distributed in the open market, the consumer can download and install the applications from the open market only after actually purchasing the electronic device, and thus it is impossible for the consumer to experience the features of the application before purchasing the actual electronic device.

### SUMMARY OF THE INVENTION

The present invention has been made in an effort to solve the above-described problems associated with prior art, and an object of the present invention is to provide a system for providing a virtual electronic device, which allows a user to experience the use of an actual electronic device like a real experience before purchasing the actual electronic device.

According to an aspect of the present invention to achieve the above object of the present invention, there is provided a system for providing a virtual electronic device, the system comprising a virtual electronic providing apparatus which includes a virtual electronic device having software and hardware interfaces for executing functions of an actual electronic device and executes the virtual electronic device in response to a request of a user terminal or transmits the virtual electronic device to the user terminal.

When a change in software of the actual electronic device occurs, the virtual electronic providing apparatus may receive the changed software from a manufacturer server of the actual electronic device and update the software for executing the functions of the actual electronic device.

The virtual electronic device may comprise: a software stack which is configured in the same manner as a software stack installed in the actual electronic device; a virtual hardware which recognizes and executes a software stack compiled for a central processing unit or processor of the actual electronic device and emulates peripheral devices included in the actual electronic device; and a device representation module which displays an exterior design of the actual electronic device.

The software stack may comprise an operating system, a middleware, an application, and an application manager, and the application manager may perform a network connection function to connect to an external server through a network and a user authentication function.

The virtual electronic device may perform an authentication process with an application server through the application manager and then download and install an application from the application server.

If the virtual hardware has an emulation function with respect to the central processing unit or processor of the actual electronic device, the virtual hardware may use the software stack without compilation.

If the virtual hardware has no emulation function with respect to the central processing unit or processor of the actual electronic device, the virtual hardware may compile the software stack to be recognized by the central processing unit or processor mounted in a device for executing the virtual electronic device.

The device representation module may parse data predefined with respect to information on the exterior design of the actual electronic device using a markup language or a predefined type of data and display an appearance of the virtual electronic device.

The software stack may be updated independently from the virtual hardware.

According to another aspect of the present invention to achieve the above object of the present invention, there is provided a system for providing a virtual electronic device, the system comprising a virtual electronic providing apparatus which receives a virtual electronic device from a virtual electronic device providing server and executes the received virtual electronic device, wherein the virtual electronic device may comprise: a software stack which is configured in the same manner as a software stack installed in an actual electronic device; a virtual hardware which recognizes and executes a software stack compiled for a central processing unit or processor of the actual electronic device and emulates peripheral devices included in the actual electronic device; and a device representation module which displays an exterior design of the actual electronic device.

### BRIEF DESCRIPTION OF THE DRAWINGS

The above and other features and advantages of the present invention will become more apparent by describing in detail exemplary embodiments thereof with reference to the attached drawings in which:

FIG. 1 is a conceptual diagram showing the configuration of a system for providing a virtual electronic device in accordance with an exemplary embodiment of the present invention; and

FIG. 2 is a block diagram showing the configuration of a virtual electronic device in accordance with an exemplary embodiment of the present invention.

### DETAILED DESCRIPTION OF THE INVENTION

While the invention is susceptible to various modifications and alternative forms, specific embodiments thereof are shown by way of example in the drawings and will herein be described in detail.

It should be understood, however, that there is no intent to limit the invention to the particular forms disclosed, but on the contrary, the invention is to cover all modifications, equivalents, and alternatives falling within the spirit and scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings. Like reference numerals in the drawings denote like elements, and thus repeated descriptions will be omitted.

In a system for providing a virtual electronic device in accordance with an exemplary embodiment of the present invention, a consumer electronic device may be an electronic device in which an application can be updated and installed through a network including a network interface and may internally comprise a hardware part and a software stack. The software stack may comprise an operating system layer, a middleware layer, and an application layer. Moreover, the software stack may have a network function to connect to the Internet such that a new application can be downloaded and installed by connecting to an external server such as an open market.

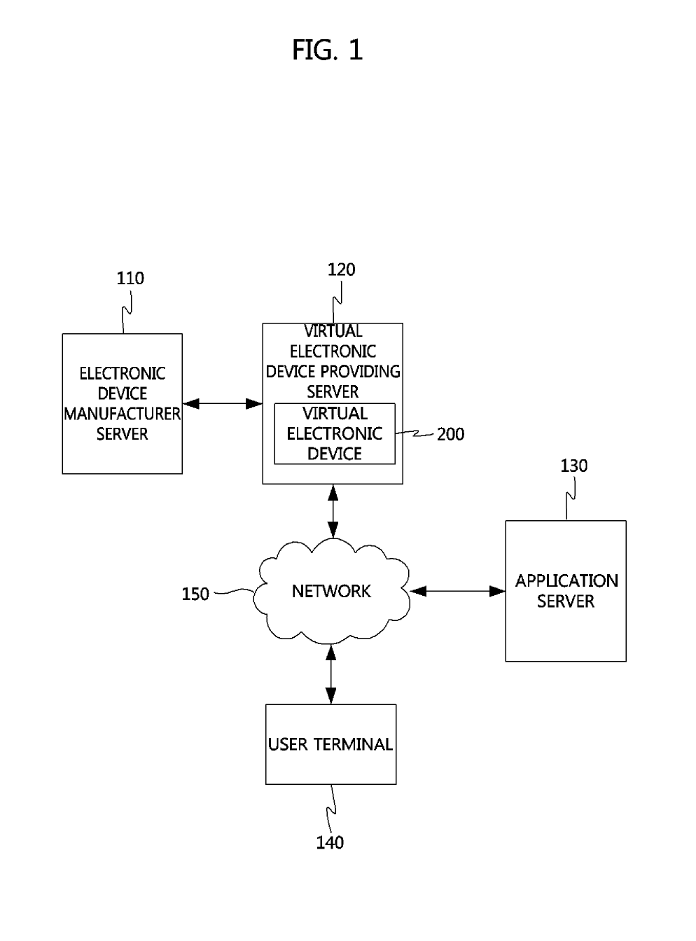

FIG. 1 is a conceptual diagram showing the configuration of a system for providing a virtual electronic device in accordance with an exemplary embodiment of the present invention.

Referring to FIG. 1, a system for providing a virtual electronic device in accordance with an exemplary embodiment of the present invention may have a structure in which an electronic device manufacturer server 110, a virtual electronic device providing server 120, an application server 130, and a user terminal 140 are connected to each other through a network 150.

The electronic device manufacturer server 110 provides a virtual electronic device 200 which satisfies the hardware and software specifications of an actual electronic device provided by an electronic device manufacturer to the virtual electronic device providing server 120. Here, the electronic device manufacturer may be a hardware platform manufacturer that manufactures the actual electronic device, a software platform vendor that provides an operating system layer, a middleware layer, or a basic application, or a distributor that can sell the integrated and software platforms. The electronic device manufacturer server 100 provides the virtual electronic device 200, which includes software corresponding to the features of the actual electronic device and a hardware interface function, to the virtual electronic device providing server 120.

The virtual electronic device providing server 120 may be, for example, an online shopping mall server that sells the virtual electronic device 200 and/or the actual electronic device corresponding to the virtual electronic device 200. Moreover, the virtual electronic device providing server 120 provides the virtual electronic device 200 provided by the electronic device manufacturer server 110 to the user terminal 140 in response to a request of the user terminal 140 or executes the virtual electronic device 200 in the virtual electronic device providing server 120. Further, when an application of the virtual electronic device 200 is provided from the application server 130 in response to the request of the user terminal 140, the virtual electronic device providing server 120 installs the application in the corresponding virtual electronic device 200.

The application server 130 may be an open market server, for example, and provide a variety of applications, which can be installed in the virtual electronic device 200, in response to the request of the user terminal 140 to the user terminal 140 or the virtual electronic device providing server 120. Here, the application server 130 may be configured to download the application of the virtual electronic device 20 after authentication in the same manner that a user, who has purchased the actual electronic device, performs an authentication process to connect to the application server 130 and download the application.

The user terminal 140 may be an information processing apparatus such as a computer, mobile terminal, etc. The user terminal 140 may connect to the virtual electronic device providing server 120 through the network 150 to download and execute a predetermined virtual electronic device 200 selected by the user or to execute the corresponding virtual electronic device 200 in the virtual electronic device providing server 120 such that the user can experience the use of the actual electronic device like a real experience.

Moreover, the user terminal 140 may download an application, which will be installed in a predetermined virtual electronic device 200 selected by the user, and install the application in the corresponding virtual electronic device 200 previously downloaded. Here, the user terminal 140 may perform an authentication process with the virtual electronic device providing server 120 or the application server 130 so as to download the application.

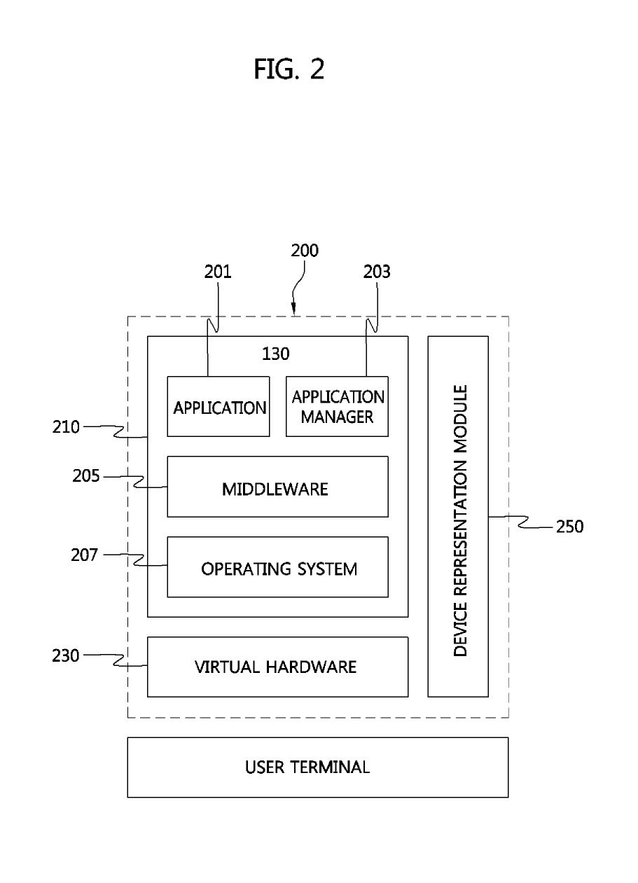

FIG. 2 is a block diagram showing the configuration of a virtual electronic device in accordance with an exemplary embodiment of the present invention.

Referring to FIG. 2, a virtual electronic device 200 in accordance with an exemplary embodiment of the present invention may be executed in the virtual electronic device providing server 120 under the execution control of the user terminal 140 or may be downloaded from the virtual electronic device providing server 120 and executed in the user terminal 140.

The virtual electronic device 200 may generally comprise a software stack 210, a virtual hardware 230, and a device representation module 250.

The software stack 210 may be configured in the same manner as a software stack installed and executed in the actual electronic device corresponding to the virtual electronic device 200 and may comprise an application 201, an application manager 203, a middleware 207, and an operating system 207.

The application manager 203 in the software stack 210 of the virtual electronic device 200 is provided with a program which is the same as a program installed in the actual electronic device to have a network connection function to connect to an external server such as the application server 130 and an authentication function. Thus, the application manager 203 can connect to the external application server 130 through an appropriate authentication process to download and install a variety of applications even if there is no actual electronic device such that the user can use the application in advance with the virtual electronic device 200.

The virtual hardware 230 serves to recognize and execute a software stack compiled for a central processing unit (CPU) or processor of the actual electronic device and to emulate peripheral devices included in the actual electronic device.

Typically, the hardware configuration of the actual electronic device is different from the hardware such as the CPU, peripheral devices, etc. included in the user terminal 140 in which the virtual electronic device 200 is executed. Thus, a machine language compiled to be read by the CPU or processor mounted in the actual electronic device has a format different from that of a machine language readable by the CPU or processor of the user terminal 140, and thus it is impossible for the virtual electronic device 200 to be executed as it is. Moreover, the user terminal 140 in which the virtual electronic device 200 is executed may be not provided with the peripheral devices included in the actual electronic device. Thus, a virtual hardware, which can recognize and execute the software stack compiled for the CPU or processor of the actual electronic device and emulate the peripheral devices of the actual electronic device, is required.

The virtual hardware 230 uses full virtualization or paravirtualization and, if the virtual hardware 230 has an emulation function with respect to the CPU or processor of the actual electronic device, may use the entire software stack 210 as it is without an additional compilation process.

Otherwise, if the virtual hardware 230 has no emulation function with respect to the CPU or processor of the actual electronic device, the virtual hardware 230 may perform a compilation process on the software stack 210 to be recognized by the CPU mounted in a device for executing the virtual electronic device 200 (e.g., the user terminal 140 or the virtual electronic device providing server 120).

The device representation module 250 displays the exterior design of the actual electronic device. Since the exterior design of the actual electronic device is very diverse, the device representation module 250 receives information on the exterior design of the actual electronic device from the virtual electronic device providing server 120 and displays the appearance of the actual electronic device through a display device (not shown) of the user terminal 140 together with the software stack 210 and the virtual hardware 230.

In the event of a change such as program debugging of the software stack in the actual electronic device, software upgrade, etc. the electronic device manufacturer may upload only the software stack 210 to the virtual electronic device providing server 120, independently from the virtual hardware 230, through the electronic device manufacturer server 110 to update the software stack 210 of the virtual electronic device 200, thereby providing a virtual electronic device 200 having the latest specifications.

Moreover, when a new actual electronic device is launched, the electronic device manufacturer may define image information used to show the exterior design of the actual electronic device and information on input and output portions of the actual electronic device into a normalized format such as an XML document and upload the information to the virtual electronic device providing server 120. Then, when the virtual electronic device 200 is executed in the user terminal 140 or the virtual electronic device providing server 120, the corresponding information is parsed by the device representation module 250 in real time such that the virtual electronic device 200 may be displayed and operated in the same manner as the actual electronic device. Here, the normalized format with respect to the exterior design and the input and output devices of the actual electronic device provided by the electronic device manufacture is not limited to the XML document but may be configured such that the device representation module 250 may dynamically parse and display a predefined type of data.

As described above, according to the system for providing the virtual electronic device of the present invention, the entire software stack for the actual electronic device provided by the manufacturer of the actual electronic device, the service provider, or the software platform vendor is installed in the virtual electronic device such that the user can experience the major features of the actual electronic device in advance before purchasing the actual electronic device.

Moreover, unlike the existing Internet shopping mall which simply provides the images and feature list of the actual electronic device, the system for providing the virtual electronic device in accordance with an exemplary embodiment of the present invention (for example, an online shopping mall) can allow the user to experience the features of the actual electronic device that the user wants to purchase through the virtual electronic device in advance, thereby providing the latest information for the purchase of the electronic device to the user.

Furthermore, according to the system for providing the virtual electronic device in accordance with an exemplary embodiment of the present invention, a new application can be downloaded from the open market in the virtual electronic device such that the user can use the application in advance with the virtual electronic device, thereby allowing the user to sufficiently review the basic and additional features of the actual electronic device that the user wants to purchase.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A system for providing a virtual electronic device, the system comprising a virtual electronic providing apparatus which includes a virtual electronic device having software and hardware interfaces for executing functions of an actual electronic device and executes the virtual electronic device in response to a request of a user terminal or transmits the virtual electronic device to the user terminal.

2. The system of claim 1, wherein when a change in software of the actual electronic device occurs, the virtual electronic providing apparatus receives the changed software from a manufacturer server of the actual electronic device and updates the software for executing the functions of the actual electronic device.

3. The system of claim 1, wherein the virtual electronic device comprises:
a software stack which is configured in the same manner as a software stack installed in the actual electronic device;
a virtual hardware which recognizes and executes a software stack compiled for a central processing unit or processor of the actual electronic device and emulates peripheral devices included in the actual electronic device; and
a device representation module which displays an exterior design of the actual electronic device.

4. The system of claim 3, wherein the software stack comprises an operating system, a middleware, an application, and an application manager, the application manager performing a network connection function to connect to an external server through a network and a user authentication function.

5. The system of claim 4, wherein the virtual electronic device performs an authentication process with an application server through the application manager and then downloads and installs an application from the application server.

6. The system of claim 3, wherein if the virtual hardware has an emulation function with respect to the central processing unit or processor of the actual electronic device, the virtual hardware uses the software stack without compilation.

7. The system of claim 3, wherein if the virtual hardware has no emulation function with respect to the central processing unit or processor of the actual electronic device, the virtual hardware compiles the software stack to be recognized by the central processing unit or processor mounted in a device for executing the virtual electronic device.

8. The system of claim 3, wherein the device representation module parses data predefined with respect to information on the exterior design of the actual electronic device using a markup language or a predefined type of data and displays the appearance of the virtual electronic device.

9. The system of claim 3, wherein the software stack is updated independently from the virtual hardware.

10. A system for providing a virtual electronic device, the system comprising a virtual electronic providing apparatus which receives a virtual electronic device from a virtual electronic device providing server and executes the received virtual electronic device, wherein the virtual electronic device comprises:
a software stack which is configured in the same manner as a software stack installed in an actual electronic device;
a virtual hardware which recognizes and executes a software stack compiled for a central processing unit or processor of the actual electronic device and emulates peripheral devices included in the actual electronic device; and
a device representation module which displays an exterior design of the actual electronic device.
